(19) United States
(12) Patent Application Publication
(10) Pub. No.: US 2009/0090772 A1
(43) Pub. Date: Apr. 9, 2009

(54) METHOD OF CHECKING TRAIN TICKETS

(75) Inventor: Shao-Ming LEE, Nan Tou (TW)

Correspondence Address: BROWDY AND NEIMARK, P.L.L.C.;624 NINTH STREET, NW, SUITE 300, WASHINGTON, DC, 20001-5303, US

(73) Assignee: Universal Scientific Industrial Co., Ltd., Tsao Tuen (TW)

(21) Appl. No.: 12/125,576

(22) Filed: May 22, 2008

(30) Foreign Application Priority Data
Oct. 9, 2007 (TW) 96137929

(51) Int. Cl. G06K 5/00

(52) U.S. Cl. 235/382

(57) ABSTRACT

A method of checking train tickets includes the steps of a) detecting authorization data stored in a ticket held by a passenger in a train station and identifiable by an RFID technology by first ticket detecting devices and sending the detected authorization data to a mainframe, b) detecting the authorization data of the ticket held by the passenger on the way of a train by at least one second ticket detecting device to check whether the authorization data detected is feasible for the passenger to take the train and sending the detected result to the mainframe, and c) detecting the authorization data of the ticket held by the passenger after the passenger gets off the train by third ticket detecting devices installed in a train station to determine whether the passenger intending to exit the train station needs to pay an excess train fare.

### BACKGROUND OF THE INVENTION

1. Field of the Invention

The present invention relates generally to a method of checking tickets, and more specifically to a method of checking train tickets, which employs a contactless identification technique such as a radio frequency identification (hereinafter referred to as “RFID”) technique.

2. Description of the Related Art

The conventional train ticket checking method is to hire ticket inspectors, who are respectively arranged at the entrances and the exits of a train station, to check tickets carried by passengers manually. Besides, a conductor will uncertainly check the tickets of the passengers on the way of a train to confirm whether the authorization datum of the tickets held by the passengers are feasible for the passengers to take the current train.

However, because of insufficient manpower, the conductor can't repeatedly check every ticket held by the passengers in a long-distance train with multiple stops, resulting in that the passengers are easy to sneak through without a ticket. Further, if the passengers take a nap or are in deep sleeping, the conductor has to wake up the passengers to successfully check the tickets such that the passengers can't obtain a good rest on the train due to the interrupted sleep. In other word, the conventional train ticket checking method has the disadvantages in that the passengers who intend to evade the necessary train fare may easily achieve their intention and the passengers who have a nap or are in deep sleeping on the train may be easily disturbed by the conductor.

### SUMMARY OF THE INVENTION

The present invention has been accomplished in view of the above-noted circumstances. It is one objective of the present invention to provide a method of checking train tickets, which can prevent the passengers from train ticket evasion. It is another objective of the present invention to provide a method of checking train tickets, which can check the tickets without disturbing the passengers.

To achieve these objectives of the present invention, the method of checking train tickets comprises the steps of a) detecting authorization data, which is stored in a ticket held by a passenger in a train station and identifiable by a contactless identification technology, by a plurality of first ticket detecting devices installed in the train station, and sending the detected authorization data to a mainframe for storage, b) detecting the authorization data of the ticket held by the passenger on the way of a train by at least one second ticket detecting device installed in the train to check whether the authorization data of the ticket held by the passengers is feasible for the passenger to take the train, and sending a detected result to the mainframe, and c) detecting the authorization data of the ticket held by the passenger after the passenger gets off the train by a plurality of third ticket detecting devices installed in the train station to determine whether the passenger intending to exit the train station needs to pay an excess train fare according to records of the mainframe.

As a result, the authorization data of the tickets held by the passengers can be recorded accurately by the mainframe such that a conductor or a ticket inspector can request the passengers without a ticket or the passengers with tickets having authorization datum mismatching with the supposed train schedule to pay the excess fare according to the records of the mainframe, thereby effectively preventing the passengers from ticket evasion.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawing which is given by way of illustration only, and thus is not limitative of the present invention, and wherein:

FIG. 1 is a flow chart of a method of checking train tickets according to the present invention.

### DETAILED DESCRIPTION OF THE INVENTION

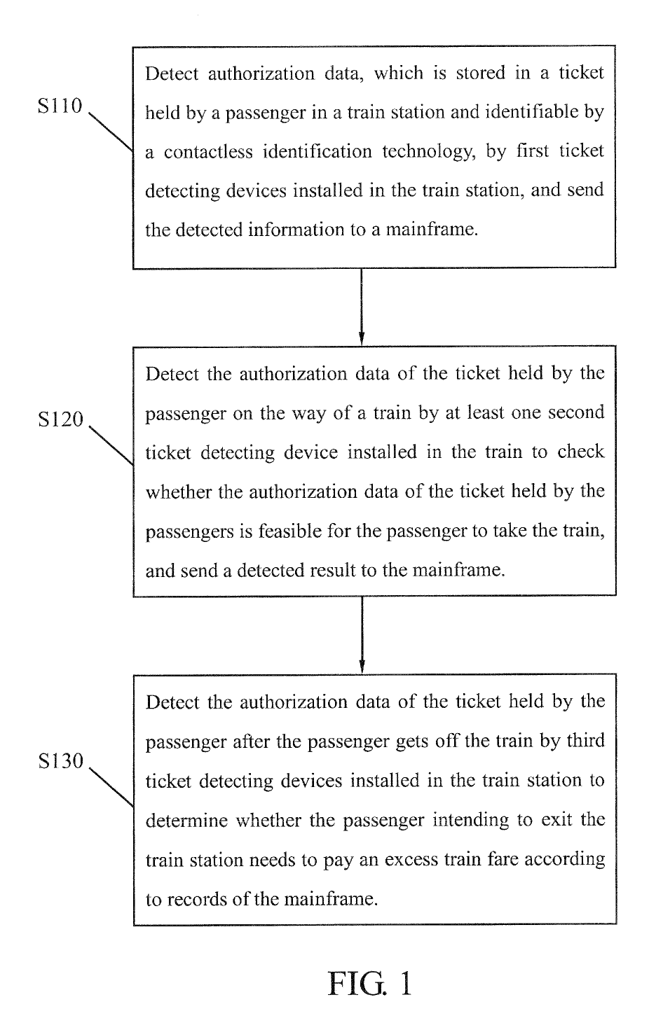

Referring to FIG. 1, a method of checking train tickets in accordance with an embodiment of the present invention includes steps S110 through S130.

The step S110 of the method is to employ a plurality of first ticket detecting devices installed in each train station to detect tickets, which is identifiable by a contactless identification technique such as an RFID technique and carried by passengers in the train station, and transmit detected information of the tickets to a mainframe. In concrete terms, each ticket comprises an RFID tag stored with an authorization data, such as departure date, departure time, train number, journey, seat number, ticket price, and etc. When the passengers enter a platform of the train station, the first ticket detecting device will detect the authorization data of each of the tickets, held by the passengers and respectively transmit the authorization datum of the tickets to the mainframe, which can directly or indirectly receive the authorization datum of the tickets and record the same. In the way of indirectly receiving the information, the first ticket detecting device transmits the detected information of the tickets to computers of the train station, and then the computers of the train station transmit the information to the mainframe.

The step S120 of the method is to employ at least one second ticket detecting device installed in the train to detect the tickets of the passengers on the way of the train for confirming whether the detected authorization datum are feasible for the passengers to take the current train, and then transmit a detected result to the mainframe. In concrete terms, the train includes a plurality of carriages, in each of which the second ticket detecting device may be installed, such that the second ticket detecting device in the carriage can detect the tickets of the passengers to judge whether the passengers in the carriage are in the proposed train schedule or overtake the train station and directly or indirectly transmit the detected result to the mainframe for records.

The step S130 of the method is to employ a plurality of third ticket detecting devices installed in each train station to detect the tickets of the passengers after the passengers get off the train and judge whether the passengers intending to exit the train station need to pay an excess train fare according to the records of the mainframe. In concrete terms, the third ticket detecting device may be embodied as a ticket collecting device, which will directly or indirectly receive the information transmitted from the mainframe. When the passengers would like to exit the train station, they have to put their tickets into ticket gates of the ticket collecting devices such that the ticket collecting devices can judge whether the passengers need to pay the excess train fare according to the records of the mainframe. If the third ticket detecting device confirms that an excess train fare needs to be paid after detection and judgment, it will generate a warning signal and show the monetary value of the excess train fare that the passenger needs to pay. As a result, an attendant of the train station can request the passenger to make up the balance.

By means of the method, the second ticket detecting device can detect the tickets of the passengers on the way of the train to judge whether the detected authorization datum of the tickets are matched with the proposed train schedule and timely send the detected information to the mainframe for records. Thus, even though the passengers overtake the station and take another train to the predetermined station of arrival, the third ticket detecting device can still judge whether an excess train fare needs to be paid according to the records of the mainframe, thereby enabling the attendant of the train station to request the passengers to pay the excess fare, if feasible.

Hereinafter another embodiment of the present invention is provided. In this embodiment, the second ticket detecting device is embodied as a portable ticket detecting device. A ticket inspector on the train can carry with the second ticket detecting device and move around the carriages of the train for detecting the tickets held by the passengers in the carriages of the train. When the second ticket detecting device detects that the tickets held by the passengers are not feasible for the passengers to take the current train, it will generate a warning signal to remind the ticket inspector. At this time, the ticket inspector can request the passengers nearby himself to show their tickets, thereby finding the passengers needing to pay the excess train fare. As a result, the efficiency of checking tickets will be enhanced and the probability of disturbing the passengers will be lowered.

Further, the second ticket detecting device can also detect the number of the tickets within a specified range such that the ticket inspector can judge whether the tickets have the same number as the passengers within the specified range. If the number of the passengers is more than the number of the tickets, this means that some passengers may not have the ticket, and then the ticket inspector can request the passengers within the specified range to show their tickets, thereby finding the passengers without the ticket and asking the passengers to pay the train fare.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of checking train tickets, comprising the steps of:
a) detecting authorization data, which is stored in a ticket held by a passenger in a train station and identifiable by a contactless identification technology, by a plurality of first ticket detecting devices installed in the train station, and sending the detected authorization data to a mainframe for storage;
b) detecting the authorization data of the ticket held by the passenger on the way of a train by at least one second ticket detecting device installed in the train to check whether the authorization data of the ticket held by the passengers is feasible for the passenger to take the train, and sending a detected result to the mainframe, and
c) detecting the authorization data of the ticket held by the passenger after the passenger gets off the train by a plurality of third ticket detecting devices installed in the train station to determine whether the passenger intending to exit the train station needs to pay an excess train fare according to records of the mainframe.

2. The method as claimed in claim 1, wherein the ticket comprises an RFID tag.

3. The method as claimed in claim 1, wherein the train includes a plurality of carriages, in each of which the second ticket detecting device is installed.

4. The method as claimed in claim 1, wherein the train has at least one ticket inspector thereon carrying the second ticket detecting device to detect tickets of passengers on the train for requesting the passenger without a ticket or the passenger having a ticket with an authorization data not feasible for the passenger to take the train to pay an excess train fare.

5. The method as claimed in claim 1, wherein the third ticket detecting device is a ticket collecting device, which will generates a warning signal when it determines that an excess train fare needs to be paid.

6. The method as claimed in claim 5, wherein the third ticket detecting devices can show the monetary value of the excess train fare that needs to be paid.
